(19) United States
(12) Patent Application Publication
(10) Pub. No.: US 2014/0082049 A1
(43) Pub. Date: Mar. 20, 2014

(54) METHOD FOR MEDIA-DATA BROADCASTING BETWEEN COMMUNICATION NETWORK USERS

(71) Applicant: Kanan Abbas Babayev, Shaki (AZ)

(72) Inventor: Kanan Abbas Babayev, Shaki (AZ)

(21) Appl. No.: 13/621,901

(22) Filed: Sep. 18, 2012

(51) Int. Cl. G06F 15/16

(52) U.S. Cl. 709/203

(57) ABSTRACT

The present invention relates to communication technology between communication network users; in particular, to a method for media-data broadcasting between communication network users and to a system designed for this purpose and may be applied in any field of media-data broadcasting.

The method includes communication network log-on of a sending user, selecting by the sending user at least one receiving user, media-data broadcasting from the sending user electronic device to the electronic device of at least one receiving user, displaying and/or playing of the broadcasted media-data on the screen of the receiving user electronic device, wherein displaying and/or playing of the broadcasted media-data on the screen of the receiving user electronic device is initiated in real-time without receiving user participation.

The method allows communication network users to realize broadcasting media-data in any location without using any additional hardware but the electronic device.

The present invention relates to a communication technology between communication network users, in particular, to a method for media-data broadcasting between communication network users and to a system for the said method realization and may be applied in any field of the media-data broadcasting.

At present, media-data broadcastings become more and more widespread, since they are a convenient means for communication network users interaction around the world. They allow to show the unlimited number of viewers the events that occur in the real-time without waiting their termination and material processing delivering information promptly to a receiving user. However, high cost of the equipment for broadcasting management and complexity of its usage does not allow to majority of those wishing clients to take these advantages. Therefore, at the moment there is still a need of designing of such method for media-data broadcasting between communication network users which will become available for all wishing clients and will allow to receive users' opinions of broadcastings in form of test messages and media-data broadcastings and for its realization a minimum of hardware and software will be needed.

The closest analogue of the claimed invention is the system and the method for media-data broadcasting arrangement control and the control protocol described in the patent No RU 2396730 (published on 10.08.2010), wherein the system comprises a communication network and plurality of users' electronic devices being in communication with each other by means of communication network and suitable for forming of the real-time media-data broadcasting; wherein the electronic device of the sending and/or receiving user has a screen on which arrangement of media-data broadcasting displaying is performed, wherein at least the sending user of the electronic device controls individually at least a partial arrangement of media-data broadcasting displaying on each electronic device of the receiving user participating in media-data broadcasting of a specific format; further the method for realization of media-data broadcasting between at least three electronic devices of communication network users comprising steps: establishment of real-time media-data broadcasting between the electronic devices on each electronic device; making a change in media-data broadcasting and reporting to the receiving users of the electronic devices about the change only.

Among the disadvantages of the described solution may be considered the fact that the sending user has a possibility to control only the arrangement of media-data broadcasting displaying on the screen of the receiving user electronic device. In addition, the electronic device, in this case, is a portable computer equipped with a videophone the use of which is conjugated with different technical and operational constraints from the size of the device to a dependence on Internet or, for example, WI-FI network connection presence.

The invention is based on the purpose to design a method for media-data broadcasting between communication network users which will allow the communication network users to realize freely real-time media-data broadcasting or pre-saved in memory of the electronic device media-data broadcasting in any location, where there is an Internet. WI-FI network and/or mobile network access without any additional hardware but the electronic device.

The solution of the assigned task is brought by that the designed method for media-data broadcasting between communication network users includes communication network log-on by the sending user, selecting by the sending user at least one receiving user, media-data broadcasting from the sending user electronic device to the electronic device of at least one receiving user, displaying and/or playing of broadcasted media-data on the screen of the receiving user electronic device, wherein displaying and playing of broadcasted media-data on the screen of the receiving user electronic device is initiated without the receiving user real-time participation. Besides, the term “sending and/or receiving user electronic device” means mobile devices, such as laptop, netbook, tablet, mobile phones, smartphones and similar devices, also desktop electronic devices, such as a personal computer and similar devices equipped with a microphone and/or camera. The said mobile and/or desktop devices of the sending and/or receiving user may comprise input-output devices. Among the input devices are the said microphone and/or camera, keyboard, mouse, stylus and similar to the said input devices. Among the output devices are the said screen, speaker and similar to the said output devices.

The term “communication network” means a network the main task of which is the different formats data broadcasting without faults and distortions.

Sending user is a communication network user who selects from a contact list in the communication network at least one receiving user, initiates and realizes media-data broadcasting using the microphone and/or camera of the electronic device.

Receiving user is a communication network user on whose electronic device displaying and/or playing of real-time broadcasted media-data and/or receiving of pre-saved in memory of the sending user electronic device media-data is realized without his/her participation. If the user does not want to participate in the displayed and/or played on his/her electronic device media-data broadcasting he/she can close, minimize it or predetermine constraint parameters for displaying and/or playing of media-data broadcastings.

According to the present invention, if the receiving user initiates response media-data broadcasting in reply to the broadcasting, the same user may be the sending and/or receiving user. Besides media-data broadcasting the receiving user can reply to the sending user with a text message.

The contact list of the sending and/or receiving user is made of the communication network users who connect to the communication network and/or have a possibility to connect. Thus, the sending user can initiate media-data broadcasting not only to at least one receiving user from his/her contact list but to the communication network users who are not registered in the said list.

Real-time media-data broadcasting is a transmission of different types of data set (including text messages) comprising additional audio and visual information through Internet, WI-FI network and/or mobile network from the execution place with insignificant for the communication network receiving user delay.

Displaying in this context should be understood as an action that results in the media-data broadcasting appearing on the electronic device screen of the communication network receiving user without his/her participation.

Playing, in this context should be understood as an action that results in the initiation of media-data broadcasting on the electronic device screen of the communication network receiving user without his/her participation.

Thus, the method provides simplicity of media-data broadcasting management from the sending user to the receiving user without using any additional hardware but the electronic device.

Preferable realization of the invention comprises the method whereby at least one type of media-data is broadcasted, wherein the type of media-data is selected from a group comprising media-data pre-saved in memory of the sending user electronic device; media-data being real-time formed by the sending user by means of the microphone and/or camera of the sending user electronic device.

In addition, media-data may be stored on the external media: USB-flash-storage device, optical discs of different types and other similar to said external media.

Thus, the method provides the sending user not only with a possibility of real-time media-data broadcasting management to the receiving user, but also with a possibility of viewing of the event recorded earlier by the sending user when, for example, the real-time media-data broadcasting was impossible.

The realization of the invention which provides for simultaneous displaying and/or playing on the receiving user device without the participation of the receiving user of several media-data broadcastings from at least one sending user in the form of a list arranged according to at least one parameter set by the receiving user is preferred.

Thus, if several sending users simultaneously select from their communication network contact lists the same receiving user for media-data broadcasting then all the broadcastings will be displayed and/or played in the form of list arranged according to the parameter set by the receiving user on the receiving user electronic device, which provides the receiving user with a possibility to select and/or continue watching one of the broadcastings. Thus, noneof the broadcastings will be omitted by the receiving user.

The realization of the invention which provides the communication network users with the media-data broadcastings displayed in the form of the list is preferred.

As it was mentioned above, the sending user realizes broadcasting not only to the receiving users from his/her communication network contact list but to all communication network users not registered therein. Therefore, all communication network users can view current generally available media-data broadcastings that are realized by sending users for all communication network users in the form of the list. Thus, if the communication network user at some point in time is not either the sending -or the receiving one he/she can view current generally available broadcastings and select at least one of them.

The preferred realization of the method is the realization whereby during communication network log-on a sending and/or receiving user authorisation is realized.

The sending and/or receiving user authorisation could be realized in three possible ways:

1. password access authorisation;

2. automatic password-free authorisation;

3. user password-free authorisations.

Password access authorisation is realized by means of input of the communication network user's identification number and password received earlier as a result of communication network registration.

Automatic password-free authorisation is realized automatically by means of a random identification number assignment to a user logging on to the communications network.

User password-free authorisation is executed by means of input of a random identification number by user logging-on to the communication network, wherein random identification number is generated by this user.

Identification numbers received as a result of password-free automatic authorisation and user password-free authorisation are valid during one communication session with the communication network.

Communication session in this context should be understood as a time interval between user's connection to the communication network and the moment when he/she will log-out (terminate the communication session), within which sending and/or receiving user realizes and/or receives the media-data broadcasting, transmits and/or sends pre-saved in memory of the electronic device media-data, transmits and/or receives a text message, records a current media-data broadcasting and similar to said actions.

Password access authorisation implies multiple use of one identification number and password for communication sessions realization.

Thus, if the user wants to use the communication network services at least once and does not want and/or has no possibility to register for any reason, he/she can take said last two authorisation ways.

The realization of the invention is preferred whereby in the communication network the user is assigned an <<online>>/<<offline>> status and the sending user realizes media-data broadcasting without regard to the receiving user status, wherein for the <<offline>> receiving users recording of media-data broadcasting is realized by the sending user and the said media-data are played without participation of the receiving user at the moment of the <<online>> status activation. Pre-recorded media-data broadcasting is stored on a communication network server platform.

Said status means whether the user is in the communication network at the moment. The status is set automatically without participation of sending and/or receiving user as soon as the user logs-on to or logs-out of the communication network. In case the receiving user has the <<offline>> status the sending user can record the media-data broadcasting for the receiving user and send it to said user, wherein the recorded media-data broadcasting is stored on the communication network server platform. Thus, as soon as the receiving user changes the status from <<offline>> to <<online>> the recorded broadcasting will be displayed and/or played on the receiving user electronic device without his/her participation. Such realization of the claimed invention ensures that the receiving user will see the media-data broadcasting even if his/her status at the moment of the broadcasting realization is <<offline>>.

The term server platform means at least one server included into the communication network, situated locally or at a distance from at least one another server included into the communication network.

The method for media-data broadcasting described herein can be realized in the system of media-data broadcasting between communication network users.

The system of media-data broadcasting between communication network users comprises: a communication network, a server platform and plurality of client systems based on the electronic devices of the sending and/or receiving users connected to each other by means of communication network. Client systems based on the communication network users electronic devices comprise: a user interface module, a media module, a users functions realization module. Server platform comprises a media-data broadcasting module, a service information transmission module.

A user interface module comprises processing means of the electronic device authorisation of the sending and/or receiving user necessary for realization of a communication session log-on, means for selecting other user interface modules, means for the communication session realization, means for communication session termination, addressee selector.

The concept of means relates to any hardware and/or software, cross software, microcode or any combination thereof.

Addressee selector is a means whereby at least the sending user selects from the communication network contact list at least one receiving user identifier for communication session realization.

The media module comprises the means for performing, adjusting, displaying and/or playing of media-data broadcasting.

The sending and/or receiving user functions realization module comprises means for the communication session initiation and/or realization.

The server platform comprises a media-data broadcasting module, a service information transmission module.

The media-data broadcasting module provides the communication session between at least one sending and at least one receiving user. The media-data broadcasting module comprises a first transmitter unit and/or a second transmitter unit.

The first transmitter unit realizes a real-time broadcasting and/or broadcasting of the pre-saved in memory of the sending user electronic device media-data without participation of the receiving user by means of communication channels with the server platform with saving the transmitted media-data on the server platform.

The second transmitter unit realizes a real-time broadcasting and/or broadcasting of the pre-saved in memory of the sending user electronic device media-data without participation of the receiving user by means of communication channels with the server platform without saving the transmitted media-data on the server platform.

The service information transmission module comprises a script module, a database module.

The script module comprises means for communication sessions access rights control, means for the sending and/or receiving user status verification, means for informing about communication sessions state, means for communication termination.

The information about all modules performance and about the whole system settings is stored in the database module.

### BRIEF DESCRIPTION OF THE DRAWINGS

FIG. 1 is a client system based on the sending and/or receiving user electronic device.

FIG. 2 is a server platform structure.

FIG. 3 is a scheme of the media-data broadcasting between communication network users electronic devices with saving of the transmitted media-data on the server platform.

FIG. 4 is a scheme of the media-data broadcasting between communication network users electronic devices without saving of the transmitted media-data on the server platform.

FIG. 5 is a scheme of interaction of the communication network sending and receiving users electronic devices and the server platform.

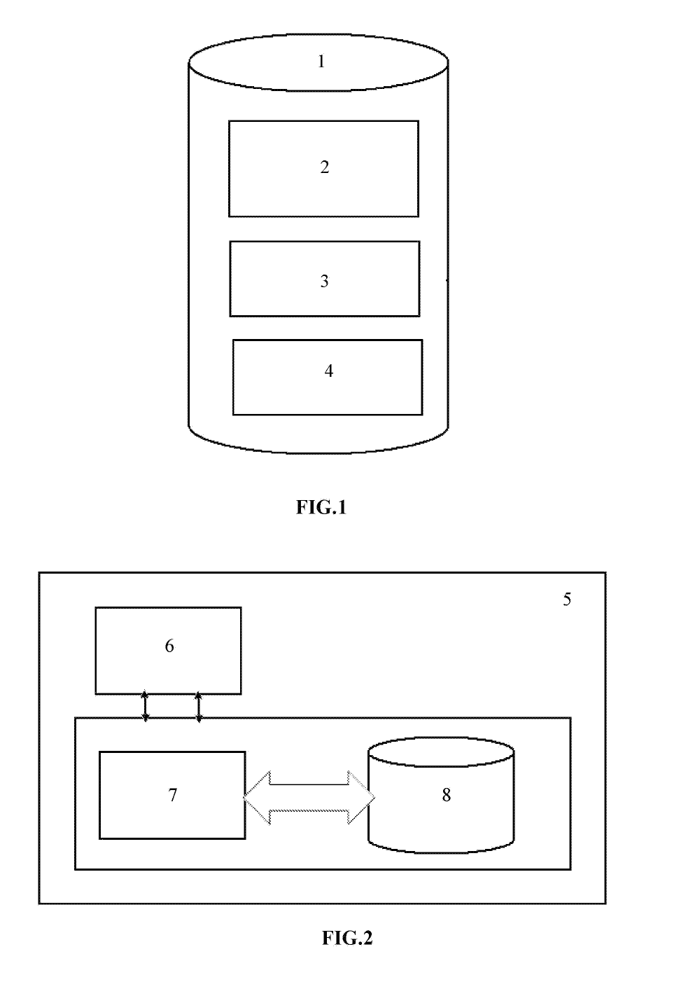

FIG. 1 shows a client system (1) based on the sending and/or receiving user electronic device comprising a user interface module (2), a media module (3), a user function realization module (4).

FIG. 2 shows a server platform structure. The server platform (5) comprises a media-data broadcasting module (6), a service information transmission module (7), a script module (8).

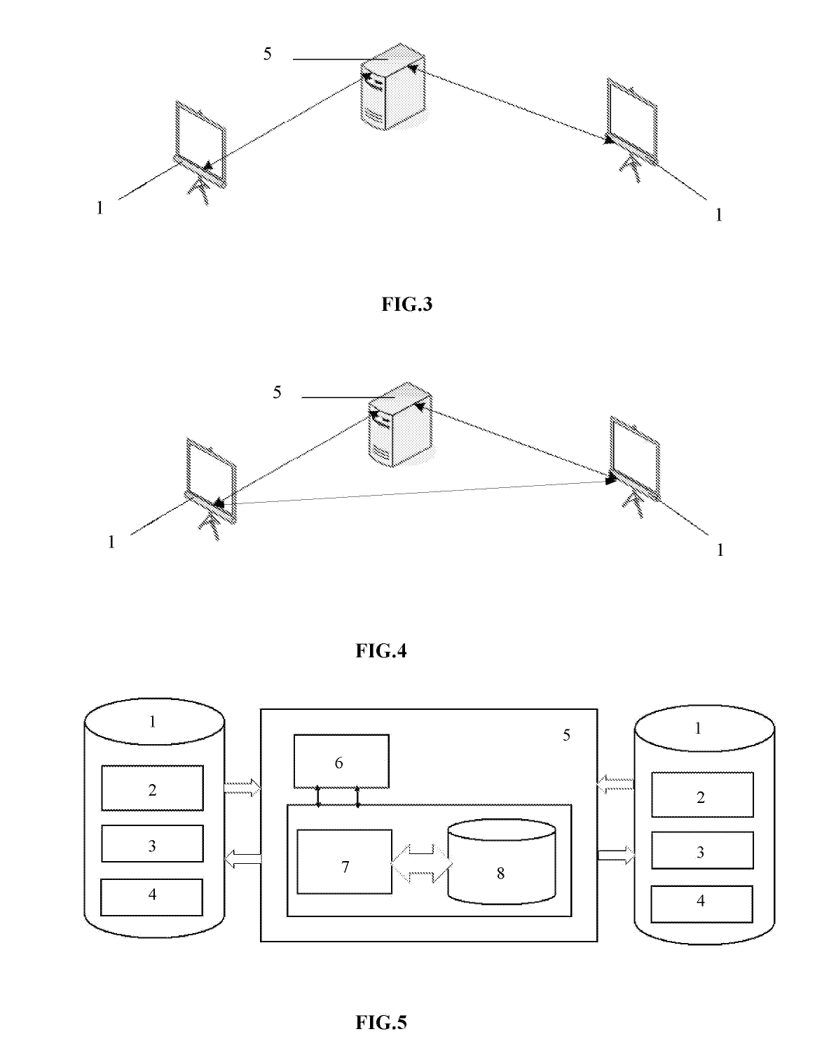

FIG. 3 shows a scheme of the media-data broadcasting between the communication network sending user electronic device (9) and the communication network receiving user electronic device (10) with the transmitted media-data with saving of the transmitted media-data on the server platform (5).

FIG. 4 shows a scheme of the media-data broadcasting between the communication network sending user electronic device (9) and the communication network receiving user electronic device (10) without saving of the transmitted media-data on the server platform (5).

FIG. 5 shows a scheme of interaction of the communication network sending user electronic device (9), the communication network receiving user electronic device (10) and the server platform (5).

Exemplary realization of the media-data broadcasting between communication network users.

Using the user interface module (2) of the client system (1) the sending user logs-on to the communication network by means of the electronic device and selects from the communication network contact list at least one receiving user, further selects what media-data will be broadcasted: pre-saved in memory of the sending user mobile device media-data or the media-data formed in real-time by means of microphone and/or camera of the sending user electronic device connected to the media module (3).

The data relating to the receiving user and to the media-data to be broadcasted are transmitted to the service information module (7). In the service information module (7) the receiving user status (<<online>>/<<offline>>) is verified and the received information is sent to the user functions realization module (4) of the receiving user for the purpose of notification of the receiving user about the initiation of the broadcasting. If the receiving user status is <<online>>, then the media-data broadcasting is initiated without his/her participation. If the user status is <<offline>>, then the saving in the database module (9) of the information about the presence of the saved broadcasting that can be displayed and/or played as soon as the receiving user status is changed to <<online>> is performed by means of the service information module (7)

Then by means of the service information transmission module (7) the name of the receiving user is transmitted to the media-data broadcasting module (6), wherein the media-data broadcasting will be displayed and/or played on the receiving user electronic device. By means of the media-data broadcasting module (6) a media-data flow is directed from the communication network sending user electronic device (9) to the communication network receiving user electronic device (10).

By means of the media module (3) the displaying and/or playing of the media-data is initiated on the communication network receiving user electronic device (10) without participation of the receiving user.

By means of the media module (3) the receiving user can adjust such parameters of playing as signal quality (for example, brightness, volume), size of the played broadcasting window (full or minimized screen) and similar to those parameters.

With regard to whether media-data broadcasting is realized with or without saving the transmitted media-data on the server platform the first or the second transmitter unit is involved into broadcasting.

Termination of the media-data broadcasting is realized by the sending user by means of selecting of the respective button in the client system (1) using communication network user functions realization module (4).

Thus, said method for media-data broadcasting between communication network users allows the communication network users to freely realize real-time media-data broadcasting or pre-saved in memory of the electronic device media-data broadcasting at any location where there is an Internet, WI-FI network and/or mobile network access without using any additional hardware but the electronic device.

1. A method for media-data broadcasting between communication network users comprising
sending user communication network log-on,
selecting by the sending user at least one receiving user,
media-data broadcasting from the sending user electronic device to the at least one receiving user electronic device,
displaying and/or playing of broadcasted media-data on the receiving user electronic device screen,
wherein the displaying and playing of the broadcasted media-data on the receiving user electronic device screen is initiated without participation of the receiving user.

2. A method of claim 1, wherein at least one type of media-data selected from a group is broadcasted, wherein the group comprises: pre-saved in memory of the sending user electronic device media-data; media-data formed in real-time by the sending user by means of the sending user electronic device microphone and/or camera.

3. A method of claim 1, wherein several media-data broadcastings from at least one sending user are displayed and/or played simultaneously on the receiving user electronic device without participation of the receiving user.

4. A method of claim 3, wherein displaying and/or playing of broadcastings is realized in the form of a list, arranged by at least one parameter set by the receiving user.

5. A method of claim 1, wherein for the communication network users the media-data broadcastings are displayed in the form of a list.

6. A method of claim 1, wherein during the log-on to the communication network the sending user and/or receiving user authorisation is realized.

7. A method of claim 1, wherein the user is assigned the <<online>>/<<offline>> status in the communication network.

8. A method of claim 7, wherein media-data broadcasting is realized by the sending user without regard to the receiving user status.

9. A method of claim 7, wherein for <<offline>> receiving users recording of the media-data broadcasting is implemented by the sending user and said media-data are displayed and/or played without participation of the receiving user at the moment of the <<online>> status activation.

10. A method of claim 9, wherein the pre-recorded media-data broadcasting is stored on the communication network server platform.
